(19) United States
(12) Patent Application Publication
(10) Pub. No.: US 2026/0171649 A1
(43) Pub. Date: Jun. 18, 2026

(54) ANTENNA MODULE AND ELECTRONIC DEVICE

(71) Applicant: VIVO MOBILE COMMUNICATION CO., LTD., Guangdong (CN)

(72) Inventor: Yunfeng DONG, Guangdong (CN)

(73) Assignee: VIVO MOBILE COMMUNICATION CO., LTD., Guangdong (CN)

(21) Appl. No.: 19/388,941

(22) Filed: Nov. 13, 2025

Related U.S. Application Data
(63) Continuation of application No. PCT/CN2024/092806, filed on May 13, 2024.

(30) Foreign Application Priority Data
May 19, 2023 (CN) 202310576770.X

(51) Int. Cl. H01Q 1/22; H01Q 3/36; H01Q 5/335

(52) U.S. Cl. CPC H01Q 1/22; H01Q 3/36; H01Q 5/335

(57) ABSTRACT

An antenna module and an electronic device are provided. The antenna module includes at least one antenna radiator and a power distribution network, where a plurality of feed ports of the power distribution network are configured to connect to a plurality of corresponding feed points of the at least one antenna radiator, each antenna radiator including a plurality of feed points, and the power distribution network is configured to distribute a radio frequency signal to the corresponding plurality of feed points of the antenna radiator.

### CROSS-REFERENCE TO RELATED APPLICATIONS

This application is a continuation of International Application No. PCT/CN2024/092806 filed May 13, 2024, which claims priority to Chinese Patent Application No. 202310576770.X filed on May 19, 2023, which are incorporated herein by reference in their entireties.

### TECHNICAL FIELD

This application relates to the field of communications, and in particular, to an antenna module and an electronic device.

### BACKGROUND

With the development of modern communication technology, the performance, functionality, and integration level of electronic devices (for example, terminals) continue to improve to meet increasingly diverse and dynamic usage scenarios and user demands.

Currently, antenna designs in terminal devices are generally constrained by the high integration level of the terminal devices. Due to limitations in size, clearance, and excitation modes, antenna devices in terminal devices struggle to simultaneously meet multiple antenna performance metrics. For example, under typical conditions and depending on the usage environment of a terminal device, without changing the performance of the antenna device, the over the air (OTA) performance of the terminal device can be improved by increasing the transmit power at the radio frequency port. However, the specific absorption ratio (SAR) of the terminal device increases as the transmit power increases.

Without changing the existing radio frequency architecture of the device, it is challenging to improve antenna performance, which in turn affects the communication performance and user experience of terminal device.

The information disclosed in this Background section is only for enhancing the understanding of the general background of the present invention and should not be taken as an acknowledgment or an implication in any form that such information constitutes the prior art that is already known to those skilled in the art.

### SUMMARY

This application aims to provide an antenna module and an electronic device.

According to a first aspect of embodiments of this disclosure, an antenna module is provided, including a power distribution network and at least one antenna radiator, where each antenna radiator includes a plurality of feed points, a plurality of feed ports of the power distribution network are configured to connect to corresponding feed points of the antenna radiator, and the power distribution network is configured to distribute a radio frequency signal to the corresponding plurality of feed points of the antenna radiator.

According to a second aspect of embodiments of this disclosure, an electronic device is provided, including the antenna module according to the first aspect.

### BRIEF DESCRIPTION OF DRAWINGS

The above and/or additional aspects and advantages of the present invention will become apparent and readily understood from the description of embodiments in conjunction with the accompanying drawings, in which:

FIG. 1 shows a schematic structural diagram of an antenna module according to an embodiment of this application;

FIG. 2 shows a schematic structural diagram of a flexible printed circuit antenna module according to an embodiment of this application;

FIG. 3 shows a schematic structural diagram of a metal frame antenna module according to an embodiment of this application;

FIG. 4 shows a schematic structural diagram of another antenna module according to an embodiment of this application;

FIG. 5 shows a schematic structural diagram of another flexible printed circuit antenna module according to an embodiment of this application;

FIG. 6 shows a schematic structural diagram of yet another flexible printed circuit antenna module according to an embodiment of this application;

FIG. 7 shows a schematic structural diagram of yet another flexible printed circuit antenna module according to an embodiment of this application;

FIG. 8 shows a schematic structural diagram of yet another flexible printed circuit antenna module according to an embodiment of this application;

FIG. 9 shows a schematic structural diagram of yet another flexible printed circuit antenna module according to an embodiment of this application;

FIG. 10 shows a schematic structural diagram of yet another metal frame antenna module according to an embodiment of this application;

FIG. 11 shows a schematic structural diagram of yet another metal frame antenna module according to an embodiment of this application;

FIG. 12 shows a current distribution diagram of an antenna module according to an embodiment of this application;

FIG. 13 shows a comparison diagram of efficiency between an antenna module according to an embodiment of this application and a conventional single-feed scheme;

FIG. 14 shows a comparison CDF chart of the realized gain between an antenna module according to an embodiment of this application and a conventional single-feed scheme;

FIG. 15 shows a schematic structural diagram of yet another metal frame antenna module according to an embodiment of this application;

FIG. 16 shows a schematic structural diagram of yet another metal frame antenna module according to an embodiment of this application;

FIG. 17 shows a schematic structural diagram of yet another metal frame antenna module according to an embodiment of this application;

FIG. 18 shows a schematic structural diagram of a power distribution network according to an embodiment of this application;

FIG. 19 shows a schematic structural diagram of another power distribution network according to an embodiment of this application;

FIG. 20 shows a schematic structural diagram of yet another power distribution network according to an embodiment of this application;

FIG. 21 shows a schematic structural diagram of yet another power distribution network according to an embodiment of this application; and

FIG. 22 shows a schematic diagram of an electronic device according to an embodiment of this application.

### DETAILED DESCRIPTION

Embodiments of the present invention will be described in detail below, with examples of the embodiments illustrated in the accompanying drawings, where the same or similar reference numerals denote the same or similar elements or elements having the same or similar functions throughout. The embodiments described below with reference to the drawings are exemplary, intended only to explain the present invention, and should not be construed as limiting the present invention. All other embodiments obtained by a person of ordinary skill in the art without creative efforts based on the embodiments in this application fall within the scope of protection of this application.

The terms “first” and “second” in the description and claims of this application refer to features that may expressly or implicitly include one or more such features. In the description of the present invention, unless otherwise specified, “plurality” means two or more. In addition, in the description and claims, “and/or” indicates at least one of the connected objects, and the character “/” generally indicates an “or” relationship between the associated objects.

In the description of the present invention, unless otherwise expressly specified and limited, the terms “mounted,” “connected,” and “coupled” should be understood broadly, for example, as fixed connections, detachable connections, or integral connections; mechanical connections or electrical connections; direct connections or indirect connections via an intermediate medium; or internal communication between two elements. A person of ordinary skill in the art can understand the specific meanings of these terms in the context of the present invention based on specific circumstances.

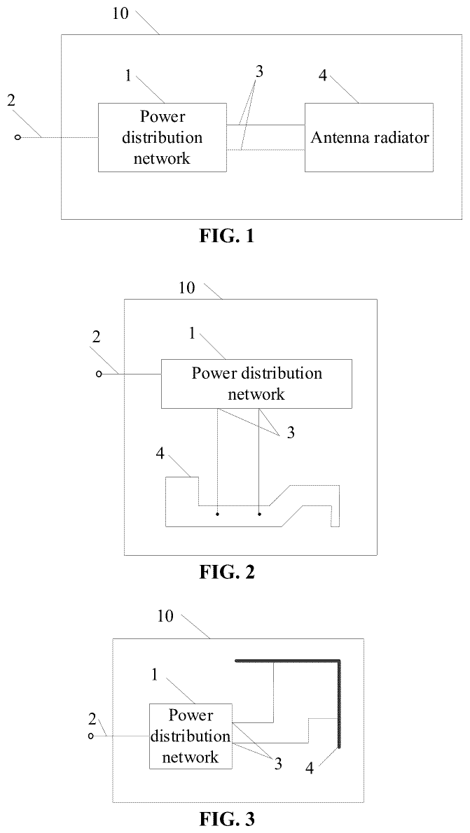

FIG. 1 shows a schematic structural diagram of an antenna module according to an embodiment of this application. As shown in FIG. 1, the antenna module 10 includes a power distribution network 1 and at least one antenna radiator 4, each antenna radiator 4 including a plurality of feed points, where a plurality of feed ports 3 of the power distribution network 1 are configured to connect to corresponding feed points of the antenna radiator 4, and the power distribution network 1 is configured to distribute a radio frequency signal to the corresponding plurality of feed points of the antenna radiator 4.

Conventional feed schemes typically are single-feed schemes, where a radio frequency signal is connected to an antenna radiator with one feed point and one grounding point. In embodiments of this application, each antenna radiator 4 may include a plurality of feed points. In some possible implementations, the antenna radiator 4 may not include a grounding point. The power distribution network 1 distributes a radio frequency signal to a plurality of feed points corresponding to one or more antenna radiators. The plurality of feed points of the at least one antenna radiator can form an antenna cluster, for example, a plurality of feed points of a single antenna radiator can form an antenna cluster, or a plurality of feed points of a plurality of antenna radiators can form an antenna cluster. Compared to conventional single-feed schemes, when each antenna radiator includes a plurality of feed points, an antenna cluster can be formed in a more flexible manner. Since the concentration effect of radiated energy is reduced, the SAR value of the electronic device can be effectively lowered under the same transmit power. In addition, forming an antenna cluster enables to excite different antenna radiation patterns, improving the directivity of the antenna far-field radiation pattern to some extent.

In some embodiments, the antenna radiator 4 may not include a grounding point. With a plurality of feed points provided on the antenna radiator, the current distribution of the antenna radiator at its operating frequency or band is changed, resulting in antenna radiation patterns that are more distinctly different from those of conventional single-feed schemes (that is, an antenna radiator with a single-feed point and a single grounding point), thereby improving the directivity of the far-field radiation pattern. In some embodiments, when the antenna radiator 4 does not include a grounding point, the size of the antenna radiator 4 may be increased by a preset scaling factor, where the preset scaling factor is greater than 1, and optionally, the preset scaling factor may be 1.2 to 2.

It is readily understood by those skilled in the art that in conventional single-feed scheme (that is, an antenna radiator with a single-feed point and a single grounding point), the size of each antenna radiator is determined based on preset antenna metrics in conjunction with antenna design (such as the number and position of antenna radiators). The size (preset size) of each antenna radiator may be the same or different. Based on this, according to the technical scheme of the embodiments of this application, a plurality of feed points can be provided on the antenna radiator, the grounding point involved in conventional single-feed schemes can be omitted, and the size of the antenna radiator can be increased by a preset scaling factor, where the preset scaling factor is greater than 1, and optionally, the preset scaling factor may be 1.2 to 2. As compared to conventional single-feed schemes, the antenna cluster formed by the technical scheme of the embodiments of this application can enhance antenna bandwidth and antenna efficiency, while the directivity of the antenna radiation pattern is improved due to changes and superposition of radiation patterns.

In some embodiments, the antenna radiator includes an antenna radiator with a grounding point and an antenna radiator without a grounding point, where the size of the antenna radiator without a grounding point is larger than the size of the antenna radiator with a grounding point.

When a plurality of antenna radiators 4 include both antenna radiators with a grounding point and antenna radiators without a grounding point, the size of the antenna radiators without a grounding point may be increased (the preset scaling factor being greater than 1, optionally the preset scaling factor being 1.2 to 2), while the size of the antenna radiators with a grounding point may remain unchanged. To be specific, when an antenna radiator does not include a grounding point, a size larger than that of an antenna radiator with a grounding point can be used as the size of the antenna radiator without a grounding point.

In some embodiments, the antenna radiator is a metal frame antenna, a flexible printed circuit antenna, or a laser direct structuring antenna, and this application does not limit the type of antenna radiator.

FIG. 2 shows a schematic structural diagram of a flexible printed circuit antenna module according to an embodiment of this application. As shown in FIG. 2, a plurality of feed ports 3 of the power distribution network 1 are connected to a plurality of feed points on the antenna radiator 4 (flexible printed circuit antenna). The antenna radiator 4 is not grounded, meaning that the grounding of the related antenna radiator is omitted. The specific arrangement of feed points can be determined through simulation calculations based on an optimization objective for antenna performance, and this disclosure does not impose specific limitations on the selection of feed points.

Since the current distribution of the antenna radiator at its operating frequency or band has changed, antenna radiation patterns that can be excited in this case are more distinctly different from those of conventional single-feed schemes. When the size of the antenna radiator is increased by a preset scaling factor (the preset scaling factor being greater than 1, optionally the preset scaling factor being 1.2 to 2), the formed antenna cluster can achieve the beneficial effects of increased bandwidth and efficiency. In addition, due to changes and superposition of radiation patterns, the directivity of the far-field radiation pattern of the antenna device is improved.

FIG. 3 shows a schematic structural diagram of a metal frame antenna module according to an embodiment of this application. As shown in FIG. 3, a plurality of feed ports 3 of the power distribution network 1 are connected to a plurality of feed points on the antenna radiator 4 (metal frame antenna). In one possible implementation, when the antenna radiator 4 is a metal frame antenna and the grounding point is omitted, the feed points can be symmetrically distributed on a plurality of antenna radiating stubs of the antenna radiator. As compared to conventional single-feed schemes, the antenna radiation patterns excited by the respective feed points are more distinctly different. In this case, the feed points may be arranged at symmetric positions, and the size of the antenna radiator 4 is increased compared to conventional single-feed schemes. When the size of the antenna radiator is increased by a preset scaling factor (the preset scaling factor being greater than 1, optionally the preset scaling factor being 1.2 to 2), the formed antenna cluster can achieve the beneficial effects of increased bandwidth and efficiency. In addition, due to changes and superposition of radiation patterns, the directivity of the far-field radiation pattern of the antenna device is improved. The specific arrangement of feed points can also be determined through simulation calculations based on an optimization objective for antenna performance, and this disclosure does not impose specific limitations on the selection of feed points.

With the adoption of the above technical scheme, a plurality of feed points are connected to the antenna radiator, such that the plurality of feed points work collaboratively to form an antenna cluster, effectively improving the performance of the antenna device without changing the external interface structure of the antenna module, thereby enhancing the communication performance and user experience of the electronic device.

In some embodiments, each antenna radiator further includes a grounding point.

Typically, the feed point can be connected to any position on the antenna radiator. The connection position of the feed point can be adjusted based on the beneficial effects and performance requirements of forming an antenna cluster.

In some possible implementations, the antenna radiator may include one radiating stub, and the grounding point may be disposed on the radiating stub. The plurality of feed points may be disposed on two sides of the grounding point or on one side of the grounding point. The distance between the plurality of feed points may be the same, for example, the plurality of feed points may be evenly distributed on the radiating stub.

In some possible implementations, the antenna radiator may include at least two radiating stubs, the radiating stubs having at least one junction, and the grounding point may be disposed at any one of the following positions:
the junction between the at least two radiating stubs;
a main radiating stub among the at least two radiating stubs, the main radiating stub being a radiating stub of the antenna radiator that supports the lowest operating frequency; and
an edge of one of the at least two radiating stubs, the edge being an end of the radiating stub away from the junction.

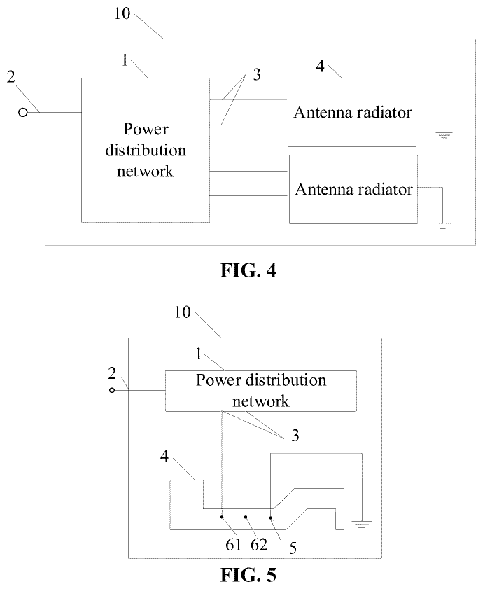

FIG. 4 shows a schematic structural diagram of another antenna module according to an embodiment of this application. As shown in FIG. 4, the antenna module includes a power distribution network 1 and at least one antenna radiator 4, each antenna radiator 4 including a plurality of feed points, where at least one antenna radiator 4 includes a grounding point 5. A plurality of feed ports 3 of the power distribution network 1 are configured to connect to corresponding feed points of the at least one antenna radiator 4, and the power distribution network 1 is configured to distribute a radio frequency signal to the corresponding plurality of feed points of the antenna radiator 4.

In some embodiments, the antenna radiator may be a flexible printed circuit antenna, the antenna radiator including at least two radiating stubs, with the grounding point disposed at the junction between the radiating stubs or at a main radiating stub among the at least two radiating stubs, where the main radiating stub is the radiating stub corresponding to the lowest operating frequency supported by the antenna radiator.

Depending on the operating frequency, the size of the radiating stub corresponding to each frequency band varies. A lower operating frequency corresponds to a longer wavelength, and its corresponding radiating stub has a larger size. Therefore, in some possible implementations, the radiating stub corresponding to the lowest operating frequency designed for the antenna radiator can be designated as the main radiating stub, and the grounding point can be disposed on this main radiating stub. In cases where the antenna radiator is designed for multiple possible operating frequencies, the grounding point may alternatively be disposed at the junction between a plurality of radiating stubs corresponding to a plurality of operating frequencies, or the antenna radiator may include only one operating frequency, that is, the antenna radiator includes only one radiating stub.

With the adoption of the above technical scheme, each antenna radiator 4 includes a plurality of feed points, and at least one antenna radiator 4 includes a grounding point 5. To be specific, each antenna radiator may include a grounding point, or only some antenna radiators may include a grounding point. The number of feed points included in different antenna radiators may be the same or different. Through the collaboration of a plurality of feed points included in multiple antenna radiators, the plurality of feed points can work collaboratively to form an antenna cluster, effectively improving the performance of the antenna device, thereby enhancing the communication performance and user experience of the electronic device.

FIG. 5 shows a schematic structural diagram of another flexible printed circuit antenna module according to an embodiment of this application. As shown in FIG. 5, the antenna radiator 4 includes a first feed point 61 and a second feed point 62, where a distance between the first feed point 61 and the grounding point 5 is less than a first preset distance threshold, the second feed point 62 is located between the first feed point 61 and the grounding point 5, and a distance between the second feed point 62 and the first feed point 61 is less than a second preset distance threshold, the second preset distance threshold being less than the first preset distance threshold.

In some possible implementations, the first preset distance threshold may be λ/4, and the second preset distance threshold may be λ/8, where λ is the free-space wavelength corresponding to the lowest operating frequency designed for the antenna radiator 4.

With the adoption of the above technical scheme, the first feed point 61 and the second feed point 62 can both achieve good self-impedance, improving the antenna efficiency of the antenna cluster while reducing the SAR value of the electronic device.

In some possible implementations, the position of the feed points can be further adjusted based on reflection parameters of the antenna module. When the self-impedance of each feed point connected to the antenna radiator 4 is less than or equal to a first preset impedance threshold, to avoid adverse effects on the impedance of the antenna cluster due to coupling between the feed points, a spacing between the first feed point 61 and the second feed point 62 may be set to be greater than a third preset distance threshold. The first preset impedance threshold may be −6 dB, and the third preset distance threshold may be

$$\frac{{λ}_{h}}{16} ,$$

where λₕ is an actual wavelength corresponding to the highest operating frequency designed for the antenna radiator. The actual wavelength is a wavelength in practical application scenarios obtained through calculation or simulation considering the overall design of the antenna module.

In another possible implementation, when the self-impedance of each feed point connected to the antenna radiator is less than or equal to the first preset impedance threshold, to avoid adverse effects on the impedance of the antenna cluster due to coupling between the feed points, a decoupling structure may be introduced between the first feed point 61 and the second feed point 62.

With the adoption of the above technical scheme, a plurality of feed points can be connected to at least one antenna radiator, such that the plurality of feed points work collaboratively to form an antenna cluster, effectively improving the performance of the antenna device, thereby enhancing the communication performance and user experience of the electronic device.

In another possible implementation, when the self-impedance of each feed point connected to the antenna radiator 4 is greater than a second preset impedance threshold, a spacing between the first feed point 61 and the second feed point 62 may be set to be less than a fourth preset distance threshold. The second preset impedance threshold may be −6 dB, and the fourth preset distance threshold may be

$$\frac{{λ}_{l}}{16} ,$$

where λₗ is an actual wavelength corresponding to the lowest operating frequency designed for the antenna radiator 4. The actual wavelength is a wavelength in practical application scenarios obtained through calculation or simulation considering the overall design of the antenna module.

With the adoption of the above technical scheme, a plurality of feed points in the antenna radiator are connected, so that coupling waves between the feed points and return waves at respective feed positions undergo destructive interference, forming an antenna cluster, thereby improving the impedance of the antenna device and achieving the beneficial effects of increased antenna bandwidth and efficiency.

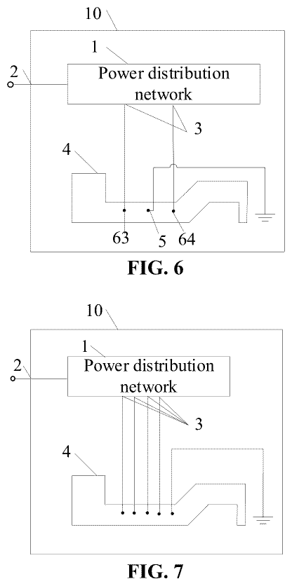

FIG. 6 shows a schematic structural diagram of another flexible printed circuit antenna module according to an embodiment of this application. As shown in FIG. 6, the antenna radiator 4 includes a third feed point 63 and a fourth feed point 64, where the third feed point 63 and the fourth feed point 64 are disposed on two sides of the grounding point 5, and a spacing between the third feed point 63 and the fourth feed point 64 is less than a fifth preset distance threshold.

In some possible implementations, the fifth preset distance threshold may be λ/4, where λ is the free-space wavelength corresponding to the lowest operating frequency designed for the antenna radiator 4.

With the adoption of the above technical scheme, a plurality of feed points in the antenna radiator are connected, so that coupling waves between the feed points and return waves at respective feed positions undergo destructive interference, forming an antenna cluster, thereby improving the impedance of the antenna device and achieving the beneficial effects of increased antenna bandwidth and efficiency.

In some embodiments, the correspondence between the feed ports 3 of the power distribution network 1 and the antenna radiator 4 can be flexibly configured based on the needs and beneficial effects of forming an antenna cluster. For example, a plurality of feed ports 3 of the power distribution network 1 can be connected to a plurality of feed points of a single antenna radiator 4. Alternatively, each feed port 3 of the power distribution network 1 can be connected to a corresponding antenna radiator 4 through a feed point. In addition, a plurality of feed ports 3 of the power distribution network 1 can be connected to corresponding antenna radiators 4 through feed points, with each antenna radiator 4 connected to at least one feed port 3 of the power distribution network 1 through the plurality of feed points.

FIG. 7 shows a schematic structural diagram of yet another flexible printed circuit antenna module according to an embodiment of this application. As shown in FIG. 7, a plurality of feed ports 3 of the power distribution network 1 are connected to a plurality of feed points in the antenna radiator 4.

The antenna radiator 4 includes at least two radiating stubs, and the grounding point 5 may be disposed at the junction between the radiating stubs or at a main radiating stub among the at least one radiating stub, where the main radiating stub may be a radiating stub corresponding to the lowest operating frequency designed for the antenna radiator 4.

The positions of the plurality of feed points can be flexibly arranged as needed. In some possible implementations, the specific position of each feed point on the antenna radiator 4 may be determined through simulation based on an optimization objective for antenna performance, and this disclosure does not limit the specific connection positions. For example, the plurality of feed points may alternatively be flexibly disposed on two sides of the grounding point 5.

With the adoption of the above technical scheme, the coupling effect between feed points can be utilized to improve the performance of the antenna device, and in addition, due to the use of a plurality of feed points, different radiation patterns are excited, allowing the radio frequency signal to radiate through different positions of the antenna radiator, decreasing the concentration effect of radiated energy and reducing the SAR value of the electronic device.

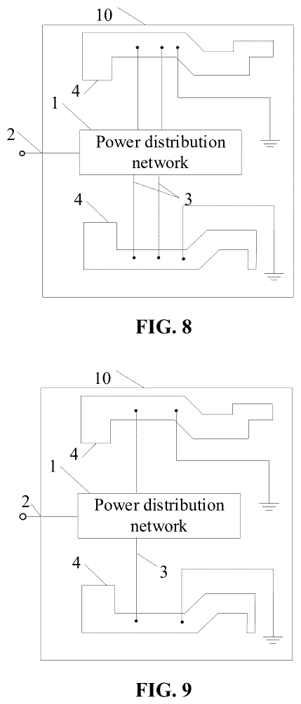

FIG. 8 shows a schematic structural diagram of yet another flexible printed circuit antenna module according to an embodiment of this application. As shown in FIG. 8, the antenna module 10 includes two antenna radiators 4, with a plurality of feed ports 3 of the power distribution network 1 respectively connected to a plurality of feed points of the two antenna radiators 4, where each antenna radiator includes two feed points. FIG. 9 shows a schematic structural diagram of yet another flexible printed circuit antenna module according to an embodiment of this application. As shown in FIG. 9, the antenna module 10 includes two antenna radiators 4, with a plurality of feed ports 3 of the power distribution network 1 respectively connected to feed points of the two antenna radiators 4, where each antenna radiator includes one feed point.

Those skilled in the art can understand that the antenna module 10 may include more antenna radiators 4, and each antenna radiator 4 may include at least one feed point. The number of feed points on each antenna radiator 4 may be the same or different.

When the power distribution network 1 is connected to a plurality of antenna radiators 4 disposed at different positions in the electronic device, the positional advantages of the respective antenna radiators can be utilized in a complementary manner. The radio frequency signal can be distributed to different positions in the electronic device for radiation, decreasing the concentration effect of radiated energy and reducing the SAR value of the electronic device, and in addition, antenna radiators located at different positions in the electronic device are less likely to be simultaneously affected by the usage environment of the electronic device, reducing the impact of the human body on the performance of the antenna device and improving the stability of the antenna radiated signal.

In some embodiments, the antenna radiator may be a metal frame antenna, the antenna radiator including at least two radiating stubs. The at least two radiating stubs have at least one junction, and the grounding point is disposed at the junction between the at least two radiating stubs or at an edge of one of the at least two radiating stubs, where the edge is an end of the radiating stub away from the junction.

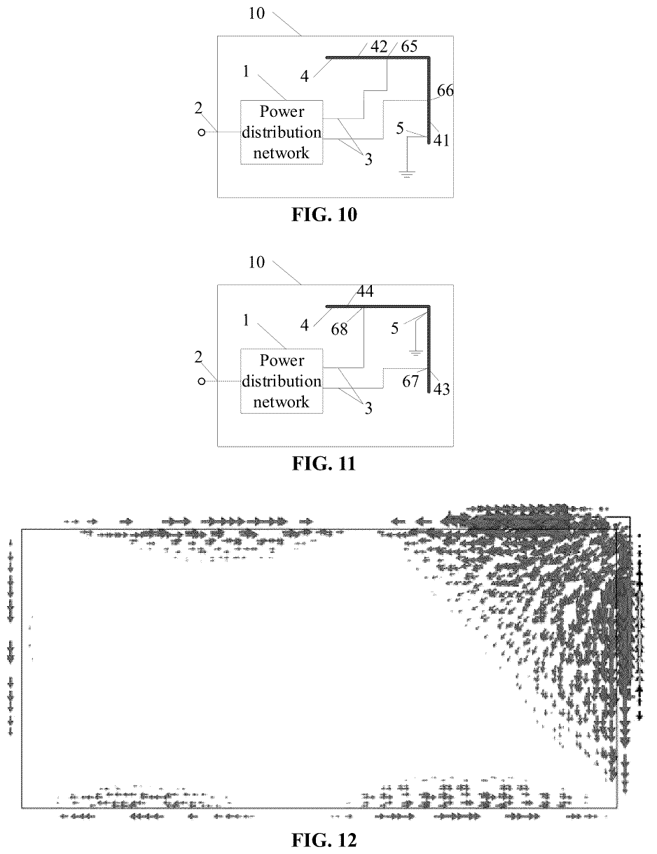

FIG. 10 shows a schematic structural diagram of yet another metal frame antenna module according to an embodiment of this application. As shown in FIG. 10, the antenna radiator 4 includes a first radiating stub 41 and a second radiating stub 42, with the grounding point 5 disposed at an edge of the first radiating stub 41, a fifth feed point 65 is disposed on the second radiating stub 42 and is located at a distance from the edge of the second radiating stub 42 that is less than a sixth preset distance threshold, and a sixth feed point 66 is disposed on the first radiating stub 41, the sixth feed point 66 being located between the fifth feed point 65 and the grounding point 5.

In some possible implementations, the sixth preset distance threshold may be λ/2, where A is the free-space wavelength corresponding to the lowest operating frequency designed for the antenna radiator.

The antenna cluster formed by the above technical scheme can effectively disperse the radiated energy of the antenna, reducing the SAR value of the electronic device.

FIG. 11 shows a schematic structural diagram of yet another metal frame antenna module according to an embodiment of this application. As shown in FIG. 11, the antenna radiator 4 includes a third radiating stub 43 and a fourth radiating stub 44, with the grounding point 5 disposed at the junction between the third radiating stub 43 and the fourth radiating stub 44, a seventh feed point 67 is disposed on the third radiating stub 43 and located at a distance from the edge of the third radiating stub that is less than a seventh preset distance threshold, and an eighth feed point 68 is disposed on the fourth radiating stub 44 and is located at a distance from the edge of the fourth radiating stub 44 that is less than an eighth preset distance threshold.

In some possible implementations, the seventh preset distance threshold may be λ/2, and the eighth preset distance threshold may be λ/2, where λ is the free-space wavelength corresponding to the lowest operating frequency designed for the antenna radiator. The seventh preset distance threshold and the eighth preset distance threshold may be the same or different.

With the adoption of the above technical scheme, when the antenna radiator is a metal frame antenna and a grounding point is arranged between the feed points, the adjustment of each feed position is more independent. The antenna cluster formed by connecting a plurality of feed points can achieve good self-impedance in its corresponding operating frequency band, enabling the antenna cluster to achieve balanced performance across a plurality of frequency bands.

FIG. 12 shows a current distribution diagram of the antenna module according to the embodiment shown in FIG. 11. As shown in FIG. 12, when the grounding point of the antenna radiator is disposed at the junction between the antenna radiating stubs according to the embodiment of FIG. 11, and the seventh feed point and the eighth feed point operate in the same frequency band, an antenna cluster is formed by distributing the radio frequency signals with equal amplitude and identical phase, and the current flow distribution indicates that the antenna cluster formed by connecting a plurality of feed points enables the amplitude and phase of the antenna radiated signals to be substantially symmetrical, thereby achieving relatively balanced performance within the operating frequency band.

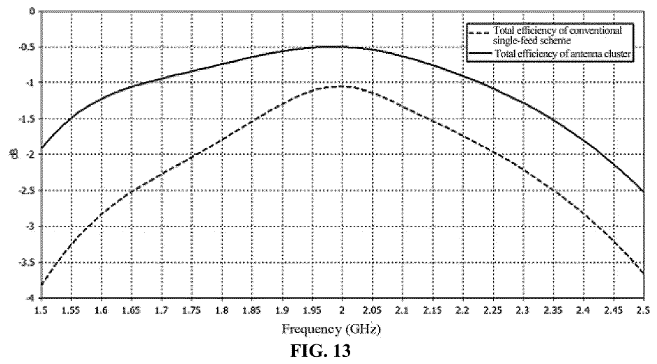

FIG. 13 shows a comparison diagram of efficiency between an antenna module according to the embodiment shown in FIG. 11 and a conventional single-feed scheme. As shown in FIG. 13, when the grounding point of the antenna radiator is disposed at the junction between the antenna radiating stubs according to the embodiment of FIG. 11, and the seventh feed point and the eighth feed point operate in the same frequency band, an antenna cluster is formed by distributing the radio frequency signals with equal amplitude and identical phase, thereby achieving significant improvement compared with a single-feed antenna module.

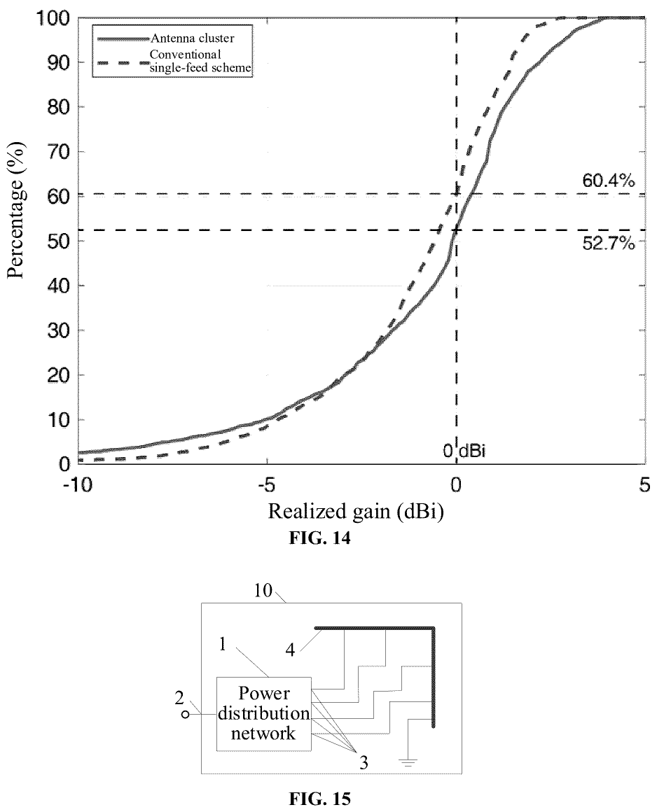

FIG. 14 shows a comparison cumulative distribution function (CDF) chart of the realized gain between the antenna module according to the embodiment shown in FIG. 11 and a conventional single-feed scheme. As shown in FIG. 14, when the grounding point 5 of the antenna radiator 4 is disposed at the junction between the antenna radiating stubs according to the embodiment of FIG. 11, and the seventh feed point 67 and the eighth feed point 68 operate in the same frequency band, an antenna cluster is formed by distributing the radio frequency signals with equal amplitude and identical phase, and the CDF curve drawn based on the realized gain of the far-field radiation pattern of the antenna cluster indicates that, as compared to the related antenna module with a single-feed point in the antenna radiator, the antenna cluster has a lower percentage at 0 dBi, indicating better omnidirectionality of the antenna cluster.

As shown in Table 1 below, when the grounding point of the antenna radiator is disposed at the junction between the antenna radiating stubs according to the embodiment of FIG. 11, and the seventh feed point 67 and the eighth feed point 68 operate in the same frequency band, an antenna cluster is formed by distributing the radio frequency signals with equal amplitude and identical phase, and under the same total transmit power and higher total antenna efficiency, the SAR value of the antenna module 10 forming the antenna cluster is significantly lower than that of the related antenna module with a single-feed point in the antenna radiator.

TABLE 1

| SAR (W/kg) | Front | Back | Short Side | Long Side |
|---|---|---|---|---|
| Antenna cluster | 1.60 | 1.59 | 0.81 | 0.63 |
| Conventional | 2.25 | 2.98 | 1.10 | 0.96 |
| single-feed scheme | | | | |

FIG. 15 shows a schematic structural diagram of yet another metal frame antenna module according to an embodiment of this application. As shown in FIG. 15, a plurality of feed ports 3 of the power distribution network 1 are connected to a plurality of feed points in the antenna radiator 4.

The antenna radiator 4 includes at least one radiating stub, and the grounding point 5 may be disposed at an edge point of any radiating stub. The positions of the plurality of feed points can be flexibly configured as needed, for example, they may be evenly distributed across a plurality of radiating stubs.

Those skilled in the art can understand that the performance of the antenna module is also related to the shape and position of the antenna radiator and the structural design of the electronic device to which the antenna module belongs. On the basis of the design of this embodiment, those skilled in the art can also adjust the position of the feed points appropriately through simulation in combination with the shape and position of the antenna radiator and the structural design of the electronic device to which the antenna module belongs.

With the adoption of the above technical scheme, the coupling effect between feed points can be utilized to improve the performance of the antenna module, and in addition, with the plurality of feed points of the antenna radiator being connected, different radiation patterns are excited, allowing the radio frequency signal to radiate through different positions of the antenna radiator, decreasing the concentration effect of radiated energy and reducing the SAR value of the electronic device.

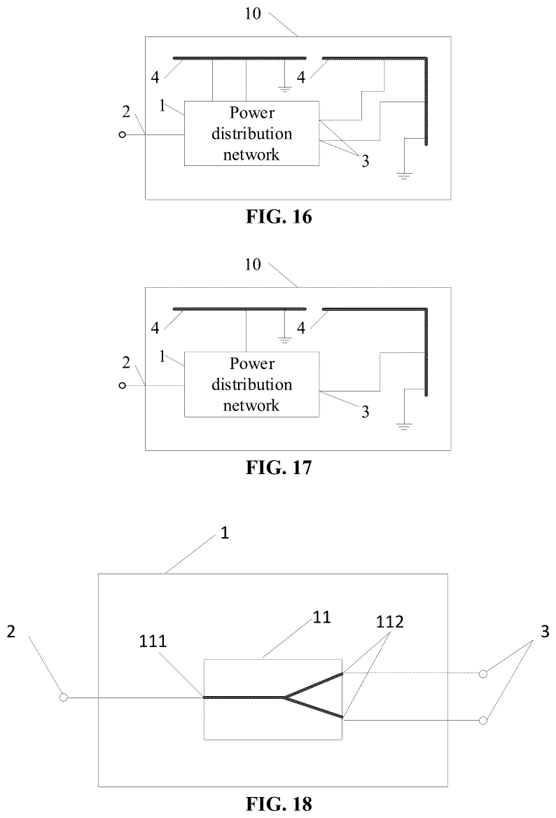

FIG. 16 shows a schematic structural diagram of yet another metal frame antenna module according to an embodiment of this application. As shown in FIG. 16, the antenna module includes two antenna radiators 4, with a plurality of feed ports 3 of the power distribution network 1 respectively connected to a plurality of feed points of the two antenna radiators 4, where each antenna radiator includes two feed points. FIG. 17 shows a schematic structural diagram of yet another metal frame antenna module according to an embodiment of this application. As shown in FIG. 17, the antenna module includes two antenna radiators 4, with a plurality of feed ports 3 of the power distribution network 1 respectively connected to feed points of the two antenna radiators 4, where each antenna radiator includes one feed point.

The grounding point 5 may be disposed at an edge point of the antenna radiator 4. The positions of the plurality of feed points can be flexibly configured as needed, for example, they may be evenly distributed across multiple antenna radiators 4.

Those skilled in the art can understand that the performance of the antenna module is also related to the shape and position of the antenna radiator and the structural design of the electronic device to which the antenna module belongs. On the basis of the design of this embodiment, those skilled in the art can also adjust the position of the feed points appropriately through simulation in combination with the shape and position of the antenna radiator and the structural design of the electronic device to which the antenna module belongs.

When the feed ports of the power distribution network are connected to a plurality of antenna radiators arranged at different positions in the electronic device, the positional advantages of the respective antenna radiators can be utilized in a complementary manner. The radio frequency signal can be distributed to different positions in the electronic device for radiation, decreasing the concentration effect of radiated energy and reducing the SAR value of the electronic device, and in addition, antenna radiators located at different positions in the electronic device are less likely to be simultaneously affected by the usage environment of the electronic device, reducing the impact of the human body on the performance of the antenna device and improving the stability of the antenna radiated signal.

The antenna module included in this application is not limited to the type, number, shape, arrangement position, and combination form of the antenna radiators 4 shown in the embodiments. For example, the antenna radiator 4 may alternatively be a laser direct structuring antenna. On the basis of the metal frame antenna or flexible printed circuit antenna described above, those skilled in the art can design and optimize the grounding point and the cc feed points for a laser direct structuring antenna based on knowledge in the field of antenna design. Those skilled in the art can understand that the antenna module 10 may include more antenna radiators 4, and each antenna radiator 4 may include a plurality of feed points. The number of feed points on each antenna radiator 4 may be the same or different. The type of antenna radiator 4 included in the antenna module 10 is not limited to the flexible printed circuit antenna or metal frame antenna mentioned in the embodiments but may alternatively be a laser direct structuring antenna. When the antenna module 10 includes a plurality of antenna radiators 4, the plurality of feed ports 3 of the power distribution network 1 may be connected to antenna radiators of the same or different types, and the number of feed points on each antenna radiator 4 may be the same or different. When the feed ports of the antenna module 10 are connected to different types of antenna radiators, their different far-field radiation characteristics can be utilized to form complementary or positive superposition of radiation patterns, for example, complementing in their respective unfavorable directions (that is, dips in the far-field radiation pattern) to improve the omnidirectionality of the antenna device or achieving positive superposition of the radiation patterns in specific directions to enhance the directivity of the antenna device.

Those skilled in the art can understand that any one or more antenna radiators with a plurality of feed points described above may alternatively be combined with conventional single-feed scheme radiators to form the antenna module of this application, enabling more flexible collaboration of the plurality of feed points to form an antenna cluster, effectively improving the performance of the antenna device, thereby enhancing the communication performance and user experience of the electronic device.

To enable the antenna cluster formed by the antenna module to achieve good performance within its operating frequency range, the power distribution network may split a radio frequency signal into a plurality of radio frequency signals and connect them to the plurality of feed points of at least one antenna radiator, improving the performance of the antenna module. In addition, the phases of the split radio frequency signals may be further adjusted. Depending on the adjustment requirements, the power distribution network in the antenna module can have various possible implementations.

FIG. 18 shows a schematic structural diagram of a power distribution network according to an embodiment of this application. As shown in FIG. 18, the power distribution network 1 includes a radio frequency port 2, a plurality of feed ports 3, and a power distribution apparatus 11. A first end 111 of the power distribution apparatus 11 is connected to the radio frequency port 2, a plurality of second ends 112 of the power distribution apparatus 11 are correspondingly connected to the plurality of feed ports 3, the radio frequency port 2 is configured to connect to a radio frequency port of a radio frequency circuit, the feed ports 3 are configured to connect to corresponding feed points, and the power distribution apparatus 11 is configured to adjust the amplitudes of the radio frequency signals between the first end 111 and the plurality of second ends 112 according to a preset power distribution parameter.

In some possible implementations, the feed points corresponding to the feed ports 3 may be a plurality of feed points corresponding to at least one antenna radiator, with each antenna radiator including at least one feed point.

The power distribution apparatus 11 may split a radio frequency signal input through the first end 111 into a plurality of radio frequency signals with the same or different amplitudes, output them to the second ends 112, and connect them to the feed points of the antenna radiator through the corresponding feed ports 3 for output through antenna radiator. In some embodiments, the power distribution apparatus 11 is configured to adjust the amplitudes of the radio frequency signals between the first end 111 and the plurality of second ends 112 according to a preset power distribution parameter.

For example, when the number of second ends 112 of the power distribution apparatus 11 is n, the preset power distribution parameter may be Ai, where i=1 to n. The power of the radio frequency signal at the j-th second end 112 may be obtained by using the preset power distribution parameter as the power distribution ratio, for example, expressed as

$${P}_{0} \times \frac{{A}_{j}}{Sum ( {A}_{i} )} ,$$

where
P₀ may be the total power of the radio frequency signal at the first end 111, and Sum(Aᵢ) is the sum of the power distribution parameters. This application does not limit the technical solution for obtaining the power of the radio frequency signal at the second end 112 through the preset power distribution parameter.

In a case of operating at different frequencies, the preset power distribution parameter of the power distribution apparatus 11 may be the same or different. For example, for a radio frequency signal in the 2 GHz operating frequency band, the preset power distribution parameter for power distribution apparatuses of four second ends 112 may be (0.25, 0.25, 0.25, 0.25), while for a radio frequency signal in the 800 MHz operating frequency band, the preset power distribution parameter for power distribution apparatuses of four second ends 112 may be (0.3, 0.3, 0.2, 0.2). This disclosure is not limited thereto.

In some possible implementations, the preset power distribution parameter of the power distribution apparatus 11 may be a fixed power distribution parameter. For example, when the formed antenna cluster does not require dynamic adjustment of the power distribution parameter within its operating frequency, the fixed power distribution parameters may be implemented through a hardware device of the power distribution apparatus 11, splitting the radio frequency signal input at the first end 111 into a plurality of radio frequency signals corresponding to the fixed power distribution parameter, and outputting them through the second ends 112 to the corresponding feed ports 3, thereby enabling the plurality of feed ports 3 to connect to corresponding feed points of at least one antenna radiator, such that the plurality of feed points may work collaboratively to form an antenna cluster, thereby improving the performance of the antenna device.

In another possible implementation, the preset power parameters of the power distribution apparatus 11 may alternatively be dynamically adjusted in response to user configuration operations, allowing users to adjust the power distribution parameter based on the performance of the formed antenna cluster, thereby enabling more flexible adjustment of the power distribution parameter.

Those skilled in the art can understand that the power distribution apparatus 11 may also adjust the amplitude of the radio frequency signals received through the feed points at the plurality of second ends 112, combine the adjusted radio frequency signals, and send them to the radio frequency circuit through the first end 111, thereby implementing the radio frequency signal receiving function.

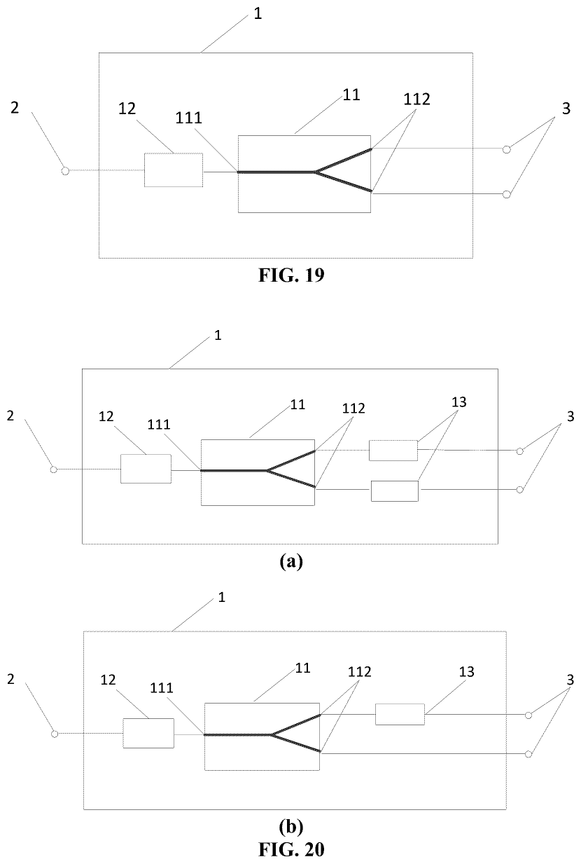

FIG. 19 shows a schematic structural diagram of another power distribution network according to an embodiment of this application. As shown in FIG. 19, the power distribution network 1 further includes a first impedance matching apparatus 12, and the first end 111 of the power distribution apparatus 11 is connected to the radio frequency port 2 through the first impedance matching apparatus 12.

In some embodiments, the first impedance matching apparatus 12 may be an impedance matching network (MN). In mobile electronic devices, antenna is required to receive and transmit radio frequency signals, and whether the impedance between the antenna module and the radio frequency circuit is matched directly affects the performance of the antenna in transmitting and receiving signals. The addition of the first impedance matching apparatus 12 to the power distribution network 1 can reduce signal reflections due to impedance mismatch, thereby improving antenna performance. In some possible implementations, the impedance matching network can be designed based on reflection parameters of the antenna and the operating frequency of the antenna cluster, and details are not elaborated herein.

The self-impedance of the antenna radiator and the coupling effect between feed points are typically vector quantities, usually represented by reflection parameters (S-parameters), where S_{mn,m=n} represents the self-impedance of the antenna radiator at the feed position, and S_{mn,m≠n} represents the coupling relationship between feed points. Therefore, the strength and direction of coupling between feed points affect the beneficial effects of forming an antenna cluster. Thus, not only does the power distribution of the radio frequency signal affect the final performance of the antenna cluster, but the phase of the radio frequency signal at each feed port also affects the performance of the antenna cluster.

FIG. 20 shows a schematic structural diagram of yet another power distribution network according to an embodiment of this application. As shown in FIG. 20, the power distribution network 1 further includes at least one phase-shifting apparatus 13, where one or more second ends 112 of the power distribution apparatus 11 are connected to corresponding feed ports 3 through the phase-shifting apparatus 13, and the phase-shifting apparatus 13 is configured to adjust the phase of the radio frequency signal according to a preset phase-shifting parameter.

By way of example, when the number of feed ports connected to the phase-shifting apparatus 13 is n, the preset phase-shifting parameters may be φi, where i=1 to n.

In case of operating at different frequencies, the phase-shifting parameters of the phase-shifting apparatus 13 may be the same or different, and this disclosure is not limited thereto.

In some possible implementations, the phase-shifting parameter of the phase-shifting apparatus 13 may be a fixed phase-shifting parameter. For example, when the formed antenna cluster does not require dynamic adjustment of the phase-shifting parameter within its operating frequency, the fixed phase-shifting parameter may be implemented by connecting a fixed phase shifter to the corresponding radio frequency line, performing a fixed phase adjustment on the radio frequency signal output to the second end 112, and performing outputting through the corresponding feed port 3 to the feed point, thereby enabling the plurality of feed ports to connect to corresponding feed points of at least one antenna radiator, such that the plurality of feed points may work collaboratively to form an antenna cluster, thereby improving the performance of the antenna device.

In another possible implementation, the phase-shifting of the phase-shifting apparatus 13 may alternatively be dynamically adjusted in response to user configuration operations, allowing users to adjust the phase-shifting parameter based on the performance of the formed antenna cluster, thereby enabling more flexible adjustment of the power distribution parameter.

In some embodiments, when the phase difference of the radio frequency signals at the corresponding plurality of feed points of the formed antenna cluster within its operating frequency is a fixed value, phase-shifting apparatuses 13 may be disposed at m feed ports of the power distribution apparatus, where m<n, and the phase adjustments of the phase-shifting apparatuses 13 at different feed ports may be the same or different. Taking FIG. 20(b) as an example, at least one feed port of the power distribution apparatus 11 with no phase-shifting apparatus 13 disposed may be used as the reference phase zero point, while phase-shifting apparatuses 13 are disposed at other feed ports, with the phase of the phase-shifting apparatuses 13 set to a phase difference relative to the reference phase zero point.

With the adoption of the above technical solution, the power distribution network can flexibly adjust the amplitude and phase of the radio frequency signals input from the radio frequency port, enabling the plurality of feed ports to connect to corresponding feed points of at least one antenna radiator, such that the plurality of feed points can work collaboratively to form an antenna cluster, thereby improving the performance of the antenna device.

Those skilled in the art can understand that the power distribution apparatus 11, through the phase-shifting apparatus 13, can also adjust the phase of the radio frequency signals received through the feed points at the plurality of second ends 112, combine the adjusted radio frequency signals, and send them to the radio frequency circuit through the first end 111, thereby implementing the radio frequency signal receiving function.

The above power distribution parameter and phase-shifting parameter can be collectively referred to as weighting coefficients of the power distribution network 1, where the weighting coefficients are vectors including power distribution and phase adjustment. Through these weighting coefficients of the power distribution network, the radio frequency signal input from the radio frequency port can be flexibly adjusted in terms of power distribution and phase, enabling the plurality of feed ports to connect to corresponding feed points of at least one antenna radiator, such that the plurality of feed points can work collaboratively to form an antenna cluster, thereby improving the performance of the antenna device.

Those skilled in the art can understand that when power distribution networks in the prior art can meet the weighting coefficient settings required by the antenna cluster within its operating frequency, such existing power distribution networks can also be used. For example, when the radio frequency signals required by a plurality of feed ports 3 of the formed antenna cluster within its operating frequency are distributed with equal power, common equal power distribution apparatuses, such as a Wilkinson power divider or a T-type power divider, can be used as the power distribution apparatus 11. Further, when the phase difference between the radio frequency signals required by a plurality of feed ports 3 is zero, the equal power distribution apparatus can be directly connected to the corresponding feed ports 3 through radio frequency lines (that is, without connecting a phase-shifting apparatus 13).

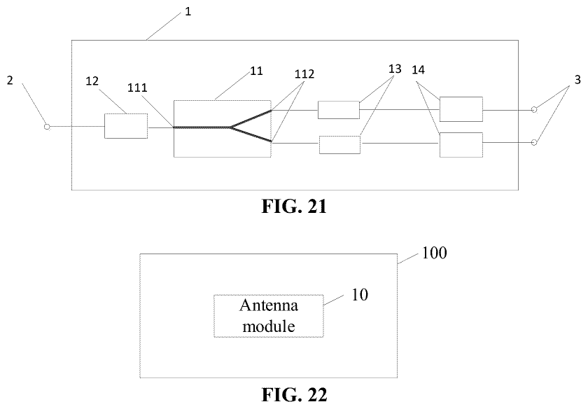

FIG. 21 shows a schematic structural diagram of yet another power distribution network according to an embodiment of this application. As shown in FIG. 21, the power distribution network 1 further includes a plurality of second impedance matching apparatuses 14, where the phase-shifting apparatus 13 or the second end 112 of the power distribution apparatus 11 is connected to the feed port 3 through the second impedance matching apparatus 14.

By way of example, when the second end 112 of the power distribution apparatus 11 is connected to a phase-shifting apparatus 13, the phase-shifting apparatus 13 may be connected to the feed port 3 through the second impedance matching apparatus 14, or when the second end 112 of the power distribution apparatus 11 is not connected to a phase-shifting apparatus 13, the second end 112 of the power distribution apparatus 11 may be connected to the feed port 3 through the second impedance matching apparatus 14. The second impedance matching apparatus 14 can adjust the self-impedance of the antenna radiator, increasing the degrees of freedom in forming the antenna cluster.

With the adoption of the above technical solution, the power distribution network can flexibly adjust the power distribution and phase of the radio frequency signal input from the radio frequency port and adjust the self-impedance of the antenna radiator, enabling the plurality of feed ports to connect to corresponding feed points of at least one antenna radiator, such that the plurality of feed points may work collaboratively to form an antenna cluster, thereby improving the performance of the antenna device.

The power distribution network 1 of the antenna module 10 included in this application may be simplified based on the actual needs of the formed antenna cluster. For example, in some cases, if phase adjustment of the radio frequency signal is not required and the beneficial effects of forming an antenna cluster can still be achieved, the power distribution network 1 can be adjusted to simplify or omit the corresponding devices, for example, using the power distribution network mentioned in the embodiments corresponding to FIG. 18 or FIG. 19, simplifying the phase-shifting apparatus.

Those skilled in the art can understand that some or all of the functions of the power distribution network 1 of the antenna module 10 included in this application can be replaced by a chip with corresponding functions, and the formed antenna cluster can achieve similar or identical beneficial effects.

FIG. 22 shows a schematic diagram of an electronic device according to an embodiment of this application. As shown in FIG. 22, the electronic device 100 includes the antenna module 10 of the first aspect described above.

The electronic device provided in this embodiment of this application may be an electronic device such as a mobile phone, tablet computer, wearable device, vehicle-mounted device, augmented reality (AR)/virtual reality (VR) device, notebook computer, ultra-mobile personal computer (UMPC), netbook, or personal digital assistant (PDA), and this disclosure does not limit the specific type of electronic device.

In some embodiments, the antenna radiator of the antenna module 10 included in the electronic device 100 may be a metal frame antenna, a flexible printed circuit antenna, or a laser direct structuring antenna, and this disclosure does not limit the type of antenna radiator.

For the antenna module of any one of the first aspects, a plurality of feed points can be connected to at least one antenna radiator, enabling the plurality of feed points to work collaboratively to form an antenna cluster, effectively improving the performance of the antenna device. The above antenna module can be equivalent to an independent antenna device and connected to the radio frequency port of the electronic device without affecting the existing radio frequency architecture.

With the adoption of the above technical solution, the antenna module forming an antenna cluster can be utilized to improve the performance of the antenna device without changing the radio frequency architecture of the electronic device, thereby enhancing the communication performance and user experience of the electronic device.

In summary, the above descriptions are only preferred embodiments of this application and are not intended to limit the scope of protection of this application. Any modifications, equivalent rearrangements, improvements, and the like made within the spirit and principles of this application should be included within the scope of protection of this application.

In the description of this specification, reference to the terms “one embodiment,” “some embodiments,” “exemplary embodiment,” “example,” “specific example,” or “some examples” means that a particular feature, structure, material, or characteristic described in connection with the embodiment or example is included in at least one embodiment or example of the present invention. In this specification, the schematic representations of the above terms do not necessarily refer to the same embodiment or example. Moreover, the described particular features, structures, materials, or characteristics may be combined in any suitable manner in any one or more embodiments or examples.

Although embodiments of the present invention have been shown and described, those skilled in the art can understand that various changes, modifications, substitutions, and variations can be made to these embodiments without departing from the principles and spirit of the present invention, and the scope of the present invention is defined by the claims and their equivalents.

What is claimed is:

1. An antenna module comprising a power distribution network and at least one antenna radiator, wherein each antenna radiator comprises a plurality of feed points, a plurality of feed ports of the power distribution network are configured to connect to the corresponding plurality of feed points of the antenna radiator, and the power distribution network is configured to distribute a radio frequency signal to the corresponding plurality of feed points of the antenna radiator.

2. The antenna module according to claim 1, wherein the antenna radiator comprises an antenna radiator with a grounding point and an antenna radiator without a grounding point, and a size of the antenna radiator without a grounding point is larger than a size of the antenna radiator with a grounding point.

3. The antenna module according to claim 1, wherein at least one antenna radiator further comprises a grounding point.

4. The antenna module according to claim 3, wherein the antenna radiator comprises at least two radiating stubs, the at least two radiating stubs having at least one junction, and the grounding point is disposed at any one of the following positions:
the junction between the at least two radiating stubs;
a main radiating stub among the at least two radiating stubs, the main radiating stub being a radiating stub of the antenna radiator that supports the lowest operating frequency; or
an edge of one of the at least two radiating stubs, the edge being an end of the one radiating stub away from the junction.

5. The antenna module according to claim 3, wherein the antenna radiator comprises a first feed point and a second feed point, a distance between the first feed point and the grounding point is less than a first preset distance threshold, the second feed point is located between the first feed point and the grounding point, and a distance between the second feed point and the first feed point is less than a second preset distance threshold, the second preset distance threshold being less than the first preset distance threshold.

6. The antenna module according to claim 5, wherein when a self-impedance of each feed point connected to the antenna radiator is less than or equal to a first preset impedance threshold, a spacing between the first feed point and the second feed point is greater than a third preset distance threshold; or
when a self-impedance of each feed point connected to the antenna radiator is greater than a second preset impedance threshold, a spacing between the first feed point and the second feed point is less than a fourth preset distance threshold.

7. The antenna module according to claim 3, wherein the antenna radiator comprises a third feed point and a fourth feed point, the third feed point and the fourth feed point are disposed on two sides of the grounding point, and a spacing between the third feed point and the fourth feed point is less than a fifth preset distance threshold.

8. The antenna module according to claim 3, wherein the antenna radiator comprises a first radiating stub and a second radiating stub, the grounding point is disposed at an edge of the first radiating stub, a fifth feed point is disposed on the second radiating stub and is located at a distance from an edge of the second radiating stub that is less than a sixth preset distance threshold, and a sixth feed point is disposed on the first radiating stub, the sixth feed point being disposed between the fifth feed point and the grounding point.

9. The antenna module according to claim 3, wherein the antenna radiator comprises a third radiating stub and a fourth radiating stub, the grounding point is disposed at a junction between the third radiating stub and the fourth radiating stub, a seventh feed point is disposed on the third radiating stub and is located at a distance from an edge of the third radiating stub that is less than a seventh preset distance threshold, and an eighth feed point is disposed on the fourth radiating stub and is located at a distance from an edge of the fourth radiating stub that is less than an eighth preset distance threshold.

10. The antenna module according to claim 1, wherein the power distribution network comprises: a radio frequency port, a plurality of feed ports, and a power distribution apparatus, a first end of the power distribution apparatus is connected to the radio frequency port, a plurality of second ends of the power distribution apparatus are correspondingly connected to the plurality of feed ports, the radio frequency port is configured to connect to a radio frequency port of a radio frequency circuit, the feed ports are configured to connect to corresponding feed points, and the power distribution apparatus is configured to adjust an amplitude of a radio frequency signal between the first end and the plurality of second ends according to a preset power distribution parameter.

11. The antenna module according to claim 10, wherein the power distribution network further comprises a first impedance matching apparatus, and the first end of the power distribution apparatus is connected to the radio frequency port through the first impedance matching apparatus.

12. The antenna module according to claim 11, wherein the power distribution network further comprises at least one phase-shifting apparatus, one or more of the second ends of the power distribution apparatus are connected to corresponding feed ports through the phase-shifting apparatus, and the phase-shifting apparatus is configured to adjust a phase of the radio frequency signal according to preset phase-shifting parameters.

13. The antenna module according to claim 12, wherein the power distribution network further comprises a plurality of second impedance matching apparatuses, and the phase-shifting apparatus or the second end of the power distribution apparatus is connected to the feed port through the second impedance matching apparatus.

14. An electronic device comprising an antenna module, wherein the antenna module comprises a power distribution network and at least one antenna radiator, each antenna radiator comprises a plurality of feed points, a plurality of feed ports of the power distribution network are configured to connect to the corresponding plurality of feed points of the antenna radiator, and the power distribution network is configured to distribute a radio frequency signal to the corresponding plurality of feed points of the antenna radiator.

15. The electronic device according to claim 14, wherein the antenna radiator of the antenna module is a metal frame antenna, a flexible printed circuit antenna, or a laser direct structuring antenna.

16. The electronic device according to claim 14, wherein the antenna radiator comprises an antenna radiator with a grounding point and an antenna radiator without a grounding point, and a size of the antenna radiator without a grounding point is larger than a size of the antenna radiator with a grounding point.

17. The electronic device according to claim 14, wherein at least one antenna radiator further comprises a grounding point.

18. The electronic device according to claim 17, wherein the antenna radiator comprises at least two radiating stubs, the at least two radiating stubs having at least one junction, and the grounding point is disposed at any one of the following positions:
the junction between the at least two radiating stubs;
a main radiating stub among the at least two radiating stubs, the main radiating stub being a radiating stub of the antenna radiator that supports the lowest operating frequency; or
an edge of one of the at least two radiating stubs, the edge being an end of the one radiating stub away from the junction.

19. The electronic device according to claim 17, wherein the antenna radiator comprises a first feed point and a second feed point, a distance between the first feed point and the grounding point is less than a first preset distance threshold, the second feed point is located between the first feed point and the grounding point, and a distance between the second feed point and the first feed point is less than a second preset distance threshold, the second preset distance threshold being less than the first preset distance threshold.

20. The electronic device according to claim 19, wherein when a self-impedance of each feed point connected to the antenna radiator is less than or equal to a first preset impedance threshold, a spacing between the first feed point and the second feed point is greater than a third preset distance threshold; or
when a self-impedance of each feed point connected to the antenna radiator is greater than a second preset impedance threshold, a spacing between the first feed point and the second feed point is less than a fourth preset distance threshold.
